(19) United States
(12) Patent Application Publication
(10) Pub. No.: US 2018/0016838 A1
(43) Pub. Date: Jan. 18, 2018

(54) ASSEMBLIES AND METHODS FOR MAKING INSULATED PANELS USING SEPARATE FACADE SURFACES

(71) Applicant: OVERHEAD DOOR CORPORATION, Lewsville, TX (US)

(72) Inventor: Charles A. Haba, Massillon, OH (US)

(73) Assignee: OVERHEAD DOOR CORPORATION, LEWISVILLE, TX (US)

(21) Appl. No.: 15/647,388

(22) Filed: Jul. 12, 2017

Related U.S. Application Data
(60) Provisional application No. 62/361,309, filed on Jul. 12, 2016.

(51) Int. Cl. E06B 3/48; E04C 2/284; E06B 3/70

(52) U.S. Cl. CPC E06B 3/485; E04C 2/284; E06B 2003/7044; E05Y 2900/106

(57) ABSTRACT

This disclosure describes methods for making insulated door panels using separate façade members, in order to separate the manufacturing process of the exterior cosmetic design surface from the structural components of the door panels. This allows a same manufacturing line for the door panels to accept façade members of different designs and to produce door panels of these different designs. The facade members are made in separate production lines using various techniques, including casting, molding, vacuum forming, extrusion, and the like. The façade members are then fed into door panel production lines that fill polyurethane foams to form complete panels. The façade members become the exterior skins of the panels with minimum overlay with any backing structure to reduce material wastes, as well as lowering tooling costs for different designs due to the common backing structure that may be shared.

### CROSS-REFERENCE TO RELATED APPLICATION

This application claims the benefit of U.S. provisional patent application No. 62/361,309, entitled “Method for Making Insulated Door Panels Using Separate Façade Surfaces”, filed on Jul. 12, 2016, which is incorporated herein by reference in its entirety.

### TECHNICAL FIELD

This disclosure relates to manufacturing garage door panels, in particular, to manufacturing insulated garage door panels.

### BACKGROUND

Exterior cosmetic design of door panels, such as those for garage doors, is often integrated with the door panels. For example, an exterior cosmetic design is often stamped onto the structural component, such as a “U” shaped steel sheet to form an exterior structure of a door panel. The exterior structure may then be married with an interior structure with expanded foam or other insulation material filled in between the exterior structure and the interior structure to form an insulated garage door panel. The tooling cost is often substantial as a result of the complicated shape of the exterior structure that includes both a design pattern and different structural elements and is thus a disincentive for providing various trendy designs.

### SUMMARY

This disclosure describes assemblies and methods for making insulated door panels using separate façade surfaces, in order to separate the manufacturing process of the exterior cosmetic design surface from the structural components of the door panels. This allows for a same production line for the door panels to accept façade surfaces of different designs and to produce door panels of these different designs and lowering the overall tooling costs for the different designs.

The facade surfaces are made in separate production lines using various techniques, including casting, molding, vacuum forming, extrusion, and the like. A particular production technique may be selected based on the desired material, cost consideration, or both. The façade surfaces are then fed into door panel production lines that fill polyurethane foams to form complete insulated garage door panels.

There are several advantages using such offline façade surfaces to make door panels. First, different door panel façade designs can be created on demand without altering the door panel production lines. Second, compared to previous manufacturing methods, a wider selection of materials and costs of the façade surfaces becomes available to the market using this method. Third, using this manufacturing method, different lamination structures (e.g., steel to foam, urethane to foam, fiberglass to foam, or wood to foam, among others) can be selected to cope with geographical requirements in terms of wind, rain, temperature variation, humidity, etc. Last but not least, the raw material for making the separated façade surface can be substantially two dimensional (such as a steel or plastic sheet) and the tooling cost for creating new and different designs on the two-dimensional raw material is significantly lowered due to the offline façade surface production.

In a first general aspect, a method for making an insulated door panel includes providing a façade surface having a design pattern. The design pattern is surrounded by a planar frontal surface near edges of the façade surface. A backing bracket is provided to receive the façade surface. The backing bracket includes a top wall, a bottom wall, and a pair of side walls to form an interior area. The façade member is aligned with the backing bracket such that a rear surface of the façade member contacts the backing bracket top wall. The façade surface is adhered to the backing bracket directly or via an expandable medium.

In some embodiments, providing the façade surface includes providing a design member onto the façade member front surface. For example, the design member may be stamped or roll-formed onto the façade member.

In some other embodiments, providing the façade surface includes stamping or roll-forming the design pattern in the originally flat piece of material to form the façade surface. For example, the originally flat piece of material is a metal sheet, such as steel.

In yet some other embodiments, providing the façade surface includes heat-forming at least one of the design pattern in the originally flat piece of material to form the façade surface. For example, the originally flat piece of material is a polymer based plastic sheet.

In some embodiments, providing the backing bracket includes providing a metal sheet and forming the metal sheet in a tool into a pan shape having a cross section of at least four folded corners. The receiving planar frontal surface if formed at an edge of the metal sheet. For example, the metal sheet can be made of steel. In some specific examples, forming the metal sheet in a tool further includes forming a groove and a tongue, wherein the groove is in between a first and a second folded corners and the tongue is in between a third and a fourth folded corners. The groove and tongue have matching outer profiles such that when the garage door is at a closed position, the groove and tongue form a barrier against rain, wind, and dust.

In yet some other embodiments, producing the planar frontal surface near edges of the façade surface includes molding a compliant material to form the planar frontal surface along with the design pattern on the façade surface. For example, the compliant material can be a curable composite that is one of urethane, a mixture of epoxy and fiberglass, and a mixture of resin and filler material.

In some embodiments, an overlay surface is adhered on top of the façade surface, wherein the overlay surface includes natural wood.

In a second general aspect, a garage door panel assembly includes a façade surface having a planar frontal surface near edges of the façade surface. A three dimensional design pattern is within the planar frontal surface. A backing bracket has a receiving planar frontal surface that is mate-able with the planar frontal surface near edges of the façade surface. The backing bracket is assembled to the façade surface. An adhesive holds the façade surface to the backing bracket.

In some embodiments, the façade surface further includes a convex guide next to the planar frontal surface. The convex guide abuts the edges of the façade surface.

In some other embodiments, the convex guide abuts a transitional planar frontal surface meeting the edges of the façade surface.

In yet some other embodiments, the backing bracket further includes a concave guide for receiving the convex guide.

In some embodiments, the backing bracket comprises at least four substantial right-angle folds.

In some other embodiments, the receiving planar frontal surface is between an edge of the backing bracket and one of the at least four substantial right-angle folds that is closest to the edge.

In yet some other embodiments, the backing bracket further comprises a groove and a tongue, the groove and the tongue having a substantially similar shape such that the tongue can fit into the groove conformingly.

In some embodiments, the façade surface is a piece of metal, a piece of urethane, a piece of composite including fiberglass and resin, or a piece of plastic.

In some other embodiments, the adhesive is expandable foam filled in between the façade surface and the backing bracket.

In a third general aspect, a garage door panel assembly includes a stainless steel backing bracket bent to form at least four bends and having a receiving planar frontal surface between an edge of the stainless steel backing bracket and one of the at least four bends closest to the edge. A flat plywood layer is mated onto the receiving planar frontal surface and aligned with the stainless steel backing bracket. A filler material fills in between the flat plywood layer and the stainless steel backing bracket for insulation and adhering the flat plywood layer to the stainless steel backing bracket. An outer layer is adhered onto the flat plywood layer, the outer layer made of real wood and shaped with decorative designs.

### DESCRIPTION OF THE FIGURES

FIG. 1A is an illustration of an assembly and method for producing an insulated garage door panel using a separate piece of façade surface.

FIG. 1B illustrates a cross sectional side view of the assembly of FIG. 1A.

FIG. 2A is a first embodiment of an assembled insulated garage door panel of FIGS. 1A and 1B.

FIG. 2B is a second embodiment of an assembled insulated garage door panel of FIGS. 1A and 1B.

FIG. 3A is a high-speed embodiment of an assembly of a steel façade surface and an backing bracket.

FIG. 3B is a high speed embodiment of an assembly of a urethane or fiberglass façade surface and the backing bracket of FIG. 3A.

FIG. 4A is another high-speed embodiment of an assembly of a steel façade surface and an backing bracket.

FIG. 4B is another high-speed embodiment of an assembly of a urethane or fiberglass façade surface and the backing bracket of FIG. 4A.

FIG. 5A is yet another high-speed embodiment of an assembly of a steel façade surface and an backing bracket.

FIG. 5B is another high-speed embodiment of an assembly of a urethane or fiberglass façade surface and the backing bracket of FIG. 5A.

FIG. 6A illustrates a front view of several garage door panels made using the assembly of separate façade surfaces.

FIG. 6B illustrates a detailed view of an example of the façade surface of FIG. 6A.

Like elements are labeled using liked reference numerals.

### DETAILED DESCRIPTION

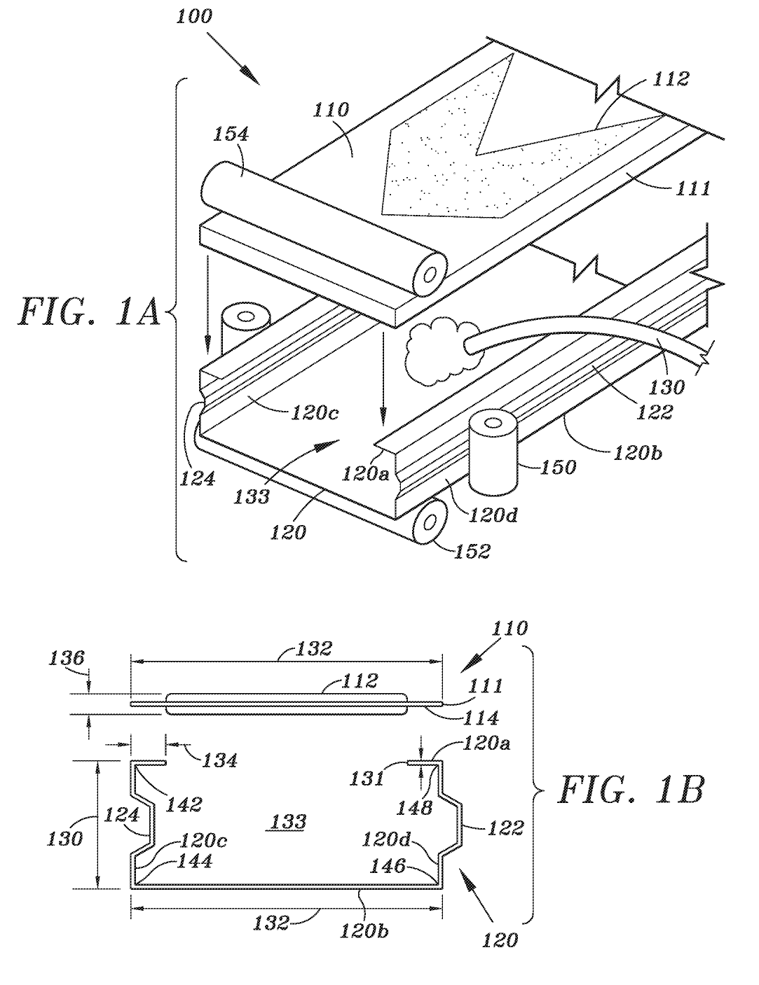

FIGS. 1A and 1B are illustrations of an insulated garage door panel assembly 100 in which a separate façade member 110 is employed to advantage. In the embodiment illustrated in FIGS. 1A and 1B, the garage door panel assembly 100 includes the façade member 110, a backing bracket 120, and a filler 130 deposited between the façade member 110 and the backing bracket 120 to act as an insulator and in some embodiments, an adhesive, to at least partially secure the façade member 110 to the bracket 120.

In the embodiment illustrated in FIG. 1B, the backing bracket 120 includes a top wall 120a, a bottom wall 120b and a pair of sidewalls 120c and 120d formed from four substantial right-angle folds 142, 144, 146 and 148 to enclose an interior area 133. In the embodiment illustrated in FIGS. 1A and 1B, the top wall 120a includes an opening 131, which enables access to the interior area 133 when filling the interior area 133 with the filler 130. When assembled, the top wall 120a, provides support to and enables attachment of the of the façade member 110 to the backing bracket 120. In particular and specifically referring to FIG. 1B, the top wall 120a of the backing bracket 120 is sized and otherwise configured to receive and/or mate with the façade member 110 near and/or otherwise adjacent to edges 111 of the façade member 110. As illustrated in FIG. 1B, for example, when the façade member 110 is secured to the backing bracket 120, the edges 111 of the façade member 110 generally align with the folds 142 and 148; however, it should be understood that the size of the façade member 110 may vary such that the edges 111 may not extend and to and otherwise align with the folds 142 and 148.

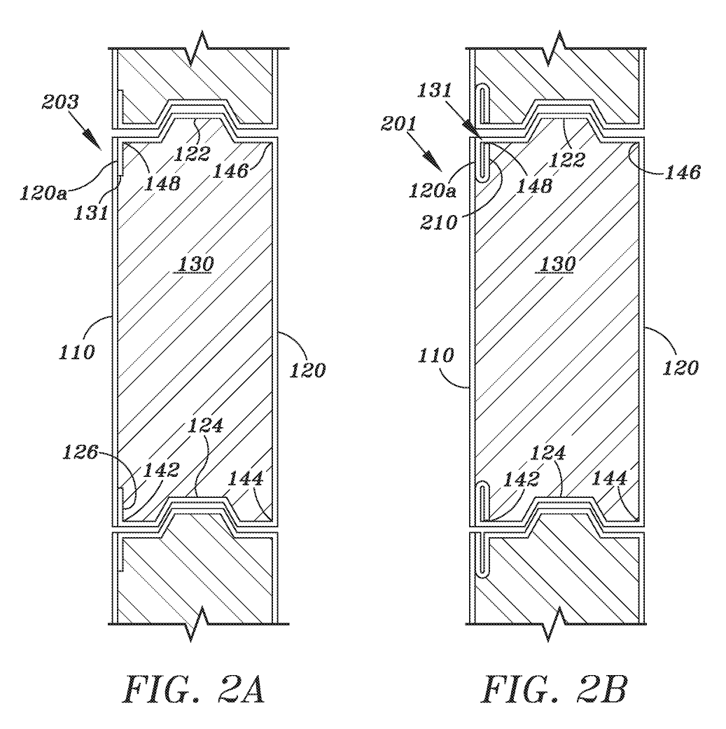

According to some embodiments, the backing bracket 120 includes a tongue 122 and a groove 124 formed in respective sidewalls 120c and 120d. The tongue 122 and the groove 124 have complementary shapes such that a tongue 122 in a first panel assembly 100 fits within the groove 124 of a second and adjacent panel assembly 100, as best illustrated, for example, in FIGS. 2A and 2B, when multiple panel assemblies 100 are secured together. When securing adjacently positioned panel assemblies 100 together, traditional panel hinges (not illustrated) are secured to the bottom wall 120b of the backing bracket 120 for pivotably connecting adjacently positioned door panel assemblies 100. According to some embodiments, the backing bracket 120 may have different thicknesses 130 and lengths 132 to accommodate different product lines.

According to some embodiments, the backing bracket 120 is formed by a separate stand-alone manufacturing process, such as, for example, roll forming, stamping, or other suitable methods. For example, according to one particular embodiment, the backing bracket 120 is produced using steel sheets that are roll-formed into a desired cross-sectional shape.

In the embodiment illustrated in FIGS. 1A and 1B, the façade member 110 includes a front surface 114 and a rear surface 115. According to some embodiments, all or a portion of the front surface 114 and/or the rear surface 115 includes a three-dimensional design or pattern 112 extending therefrom. In other embodiments, the front surface 114 and/or the rear surface 115 can be formed without any design or pattern 112 extending therefrom, can include indentations, print, can optionally can be curved, stepped or any other configuration and/or can include any combination of these particular configurations. In other embodiments, an additional overlay layer can be secured onto the front surface 114, such as, securing a natural wood overlay onto the front surface 114. According to some embodiments, the façade member 110 is formed by a separate manufacturing process, such as stamping from sheet metal, molding (such as vacuum forming or otherwise) from sheet plastic or composite materials (such as urethane, resin, epoxy and fiberglass).

During assembly, the backing bracket 120 and the façade member 110 are aligned and assembled by confining their bodies using a plurality of rollers, such as a pair of side rollers 150a and 150b, a bottom roller 152, and a top roller 154, as best illustrated in FIG. 1A. Although only four rollers 150a, 150b, 152 and 154 are illustrated, any number of rollers can be used to confine, position and/or otherwise resist relative movement of the façade member 110 and the backing bracket 120, especially when the foam 130 is deposited within the interior area 133 and expands during curing. In operation, the top roller 154 and the bottom roller 152 (or additional rollers, as needed, including downstream of the assembly line) may be used to exert a force to push or otherwise sandwich the façade member 110 and the backing bracket 120 together. It should be understood that although the bottom roller 152 and the top roller 154 are illustrated as cylindrical bodies, in some embodiments, the rollers may include two or more wheels spaced or otherwise positioned across the width of the façade member 110 or the backing bracket 120 in order to avoid contact with and potentially damaging the design pattern 112.

In addition, the side rollers 150a and 150b provide side/lateral support for the side walls 120c and 120d of the backing bracket 120 such that the side walls 120c and 120d resist and otherwise prevent deformation outwards (i.e., away from the interior area 133) under any internal pressure generated by the expandable foam 130. According to some embodiments, the side rollers 150a and 150b also function to align the façade member 110 with the backing bracket 120 such that the frontal surface 114 is aligned with the top wall 120a. Although rollers 150, 152, and 154 are illustrated to assemble the façade member 110 to the backing bracket 120, it should be understood that other methods may also be used to guide and assemble the façade surface 110 to the backing bracket 120. According to embodiments disclosed herein, the illustrated assembly method enables rapid assembly of the same backing bracket 120 to façade members 110 having different designs 112.

According to various embodiments disclosed herein, the configurations of the façade members 110 and the backing bracket 120, and in particular, the top wall 120a, may vary. For example, in the embodiment illustrated in FIG. 2B, the top wall 120a is formed having an upturned end portion 210 to increase the strength of the top wall 120a and thus, resistance to overall bending.

In some embodiments, the filler 130 is an expandable foam disposed inside the interior area 133 that functions as both an insulator and an adhesive. Thus the expandable foam 130 holds the façade surface 110 to the backing bracket 120 and fills any empty space within the interior area 133. In addition to the expandable foam functioning as an adhesive, it should be understood that other method of securing the façade member 110 to the backing bracket are available, such as, for example, the use of an adhesive provided on the top wall 120b of the backing bracket 120 or by use of bolts or any other type of securing or clamping mechanism.

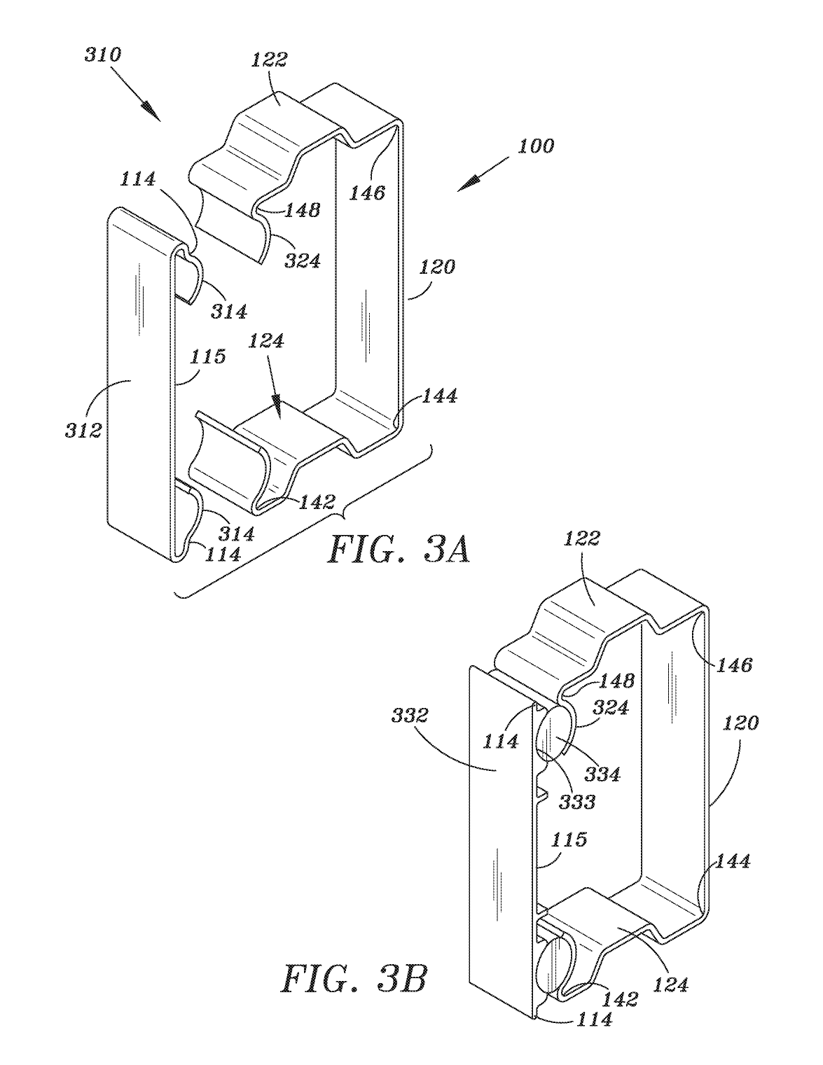

FIG. 3A is another embodiment illustrating a door panel assembly 310 having a façade member 312 attachable to a backing bracket 120. In FIG. 3A, the façade member 312 includes a self-aligning guide structure 314 extending from the edge 111 of the façade member 110 for mating with a corresponding receptacle 324 on the top wall 120a of the backing bracket 120 to facilitate high speed assembly. In operation, the self-aligning guide structure 314 is formed of a curvilinear structure extending from the edge 111 of the façade member 314 and is shaped such that as the façade member 314 is positioned adjacent to the backing bracket 120, the self-aligning structure 314 self-aligns and nests within the corresponding receptacle 324 to align the façade member 314 with the backing bracket 120. As illustrated in FIG. 3A, As illustrated, the self-aligning structure 314 is formed of a convex shape and is sized to nest within the concave receptacle 324. Such contoured coupling between the convex and concave guides 314 and 324 enables a much faster assembly speed than using the planar frontal surface 114 alone, even if the rollers 150 provides a certain amount of alignment. For example, the convex and concave guides 314 and 324 allow for a production speed of about 100 feet per minute, while using the planar frontal surfaces 114 and 120a can only allow for a production speed of about 9 feet per minute. This difference is a result of the alignment efficiency and accuracy that the convex/concave coupling contours provide. After production, such concave and convex contours may further reinforce the bending rigidity, and/or improve the overall structural integrity by enabling the façade member 312 to limit the bending movement of the tongue 122 and the groove 124. According to some embodiments, the façade member 312 is preferably formed of steel; however, it should be understood that other materials may be used for form the façade member 312.

FIG. 3B is a high speed embodiment of an assembly 320 of a urethane or fiberglass and the interior structure of FIG. 3A. The assembly 320 uses the same configuration for the backing bracket 120 and replaces the stainless steel façade surface 312 with a molded façade surface 332. The molded façade member 332 may be made from urethane, fiberglass, plastic, or other moldable materials. The façade member 332 is formed having a concave slot 333 on the planar rear surface 115 thereof. The concave slot 333 may avoid any substantial thick portion in the façade surface 332 in order to prevent molding shrinkage or other potential manufacturing defects.

In the embodiment illustrated in FIG. 3B, the concave slot 333 receives a tubular or cylindrical guide 334, which is sized to align the façade member 332 to the backing bracket 120, as similarly described above. According to some embodiments, the tubular or cylindrical guide 334 is made of a different material than the façade member 332. For example, the façade member 332 may be made from a mixture of resin and fiberglass and the tubular or cylindrical guide 334 may be made of extruded plastic or rubber. However, it should be understood that the façade member 332 and the guide 334 may be integrally formed (i.e., a single unitary piece) of the same material. Compared to the assembly 310 of FIG. 3A, the assembly 320 enjoys similar production speeds. In addition, the different geometries can be selected based on different design patterns. For example, some design patterns are more suitably formed using stamping while other design patters are more suitably formed by molding.

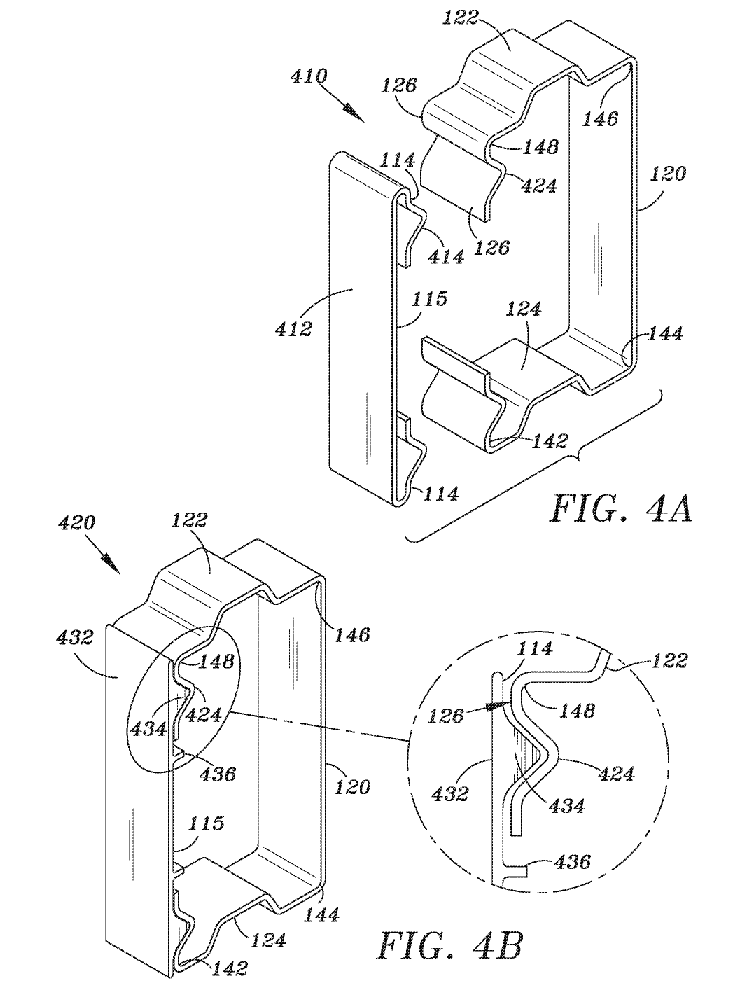

FIG. 4A is another high-speed embodiment of an assembly 410 in which a façade member 412 is employed to advantage. Similar to the façade member 312, the façade member 412 includes convex guides 414 extending from an edge of the façade member 412 for alignment during high speed production. Correspondingly, the backing bracket 120 includes corresponding concave guides 424 to receive the convex guides 414 therein. As illustrated, the convex guides 414 are formed having a triangular cross section having an apex 416; however, it should be understood that other cross-sectional shapes may be utilized. Regardless of the cross-sectional shape of the guides 414, the corresponding guide 424 is formed of a complementary shape to receive the guide 414 therein. According to preferred embodiments, the façade member 412 is formed of a steel material, however, it should be understood that other materials may be utilized.

FIG. 4B is another high-speed embodiment of an assembly 420 in which a urethane or fiberglass façade surface 432 is employed to advantage. As illustrated, the façade member 432 is formed having integral convex guide 434 for insertion within a corresponding concave guide 424 of the backing bracket 120. In some embodiments, additional structures may be provided to increase the bending stiffness of the façade surface 432, such as additional extrusions or ribs 436.

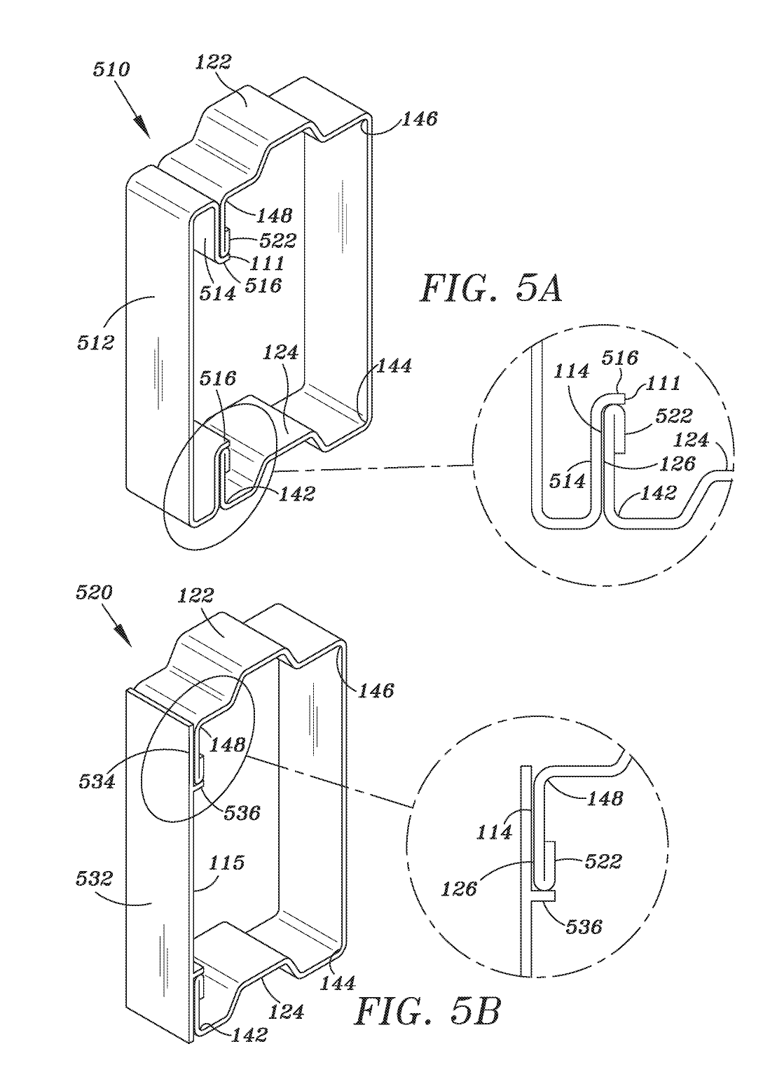

FIG. 5A is yet another high-speed embodiment of a door panel assembly 510 in which a steel façade member 512 is employed to advantage. In the embodiment illustrated in FIG. 5A, the façade member 512 includes an upturned portion 514 formed having a first leg 516 extending from a rear surface 115, a second leg 518 extending generally perpendicularly from the first leg 516 and a third leg 520, extending generally perpendicular to the second leg 518 and generally parallel to the first leg 516. As illustrated, the upturned portion 514, and in particular, the third leg 520, serves as a ledge or surface to receive and otherwise engage portions of the backing bracket 520, and in particular, a fold 511 at the edge of the. Such configuration enables high speed assembly without substantially altering the backing bracket 120 of FIGS. 1A and 1B. The backing bracket 120 may further include a fold or otherwise upturned end 522 formed on the top wall 120a. In use, the fold 522 provides a rounded contact surface for contacting and otherwise engaging the third leg 520. The assembly 510 enables similar high speed production as the assembly 310 and 410.

FIG. 5B is another high-speed embodiment of an assembly 520 in which a urethane or fiberglass façade member 532 is employed to advantage. In the embodiment illustrated in FIG. 5B, the façade member 532 includes at least one guide member 536 extending from the rear surface 115 of the façade member 532 for alignment with the upturned ends 522 of the backing bracket 120.

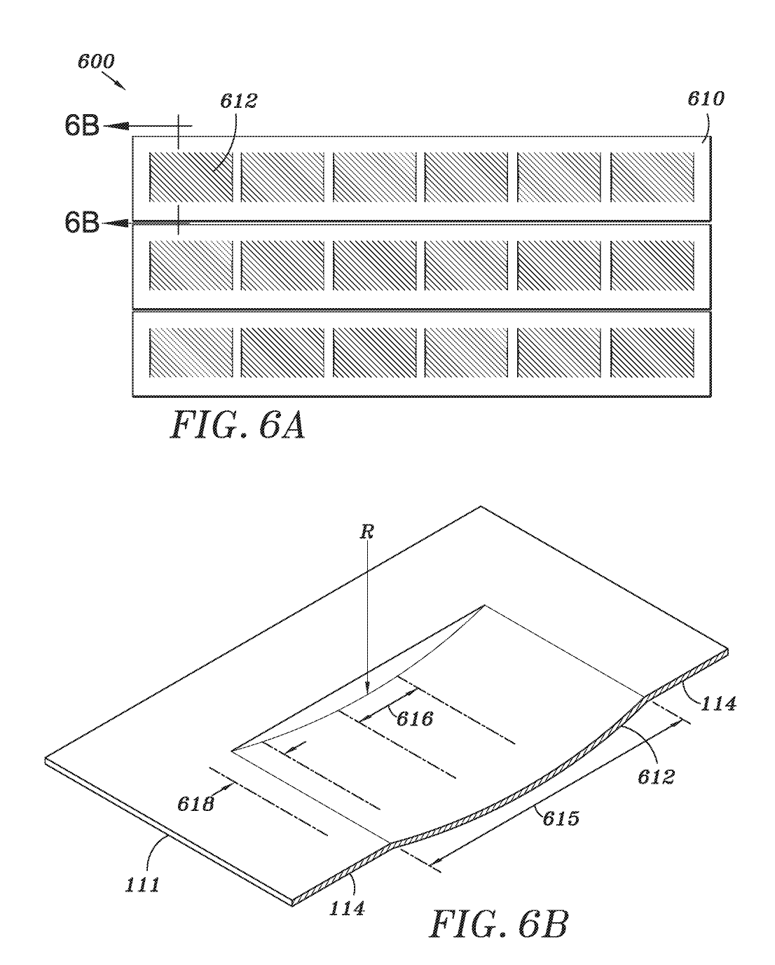

FIG. 6A illustrates a front, external view of a garage door 600 made using the assembly of separate façade members 610. FIG. 6B illustrates a detailed cross sectional view of the façade member 612 of FIG. 6A. In this example, the façade surfaces 610 are made by stamping on metal sheets to produce design pattern 612. The design pattern 612 includes a deep draw portion 616 and a transitional portion 618. The total width 615 of the design pattern 612 is less than the width of the façade member 610. During installation, the façade member 612 is coupleable to a backing bracket 120, as described above. Alternatively, the frontal surface 114 may be modified into one of the examples illustrated in FIGS. 3A, 4A, and 5A.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes some embodiments of the disclosure, and alterations, modifications, additions and/or changes can be made thereto without departing from the scope and spirit of the disclosed embodiments, the embodiments being illustrative and not restrictive.

Furthermore, the disclosure is not to be limited to the illustrated implementations, but to the contrary, is intended to cover various modifications and equivalent arrangements included within the spirit and scope of the disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A method for making an insulated door panel, the method comprising:
providing a façade member;
providing a backing bracket having a top wall, a bottom wall, and a pair of side walls to form an interior area;
aligning the façade member with the backing bracket such that a rear surface of the façade member contacts the backing bracket top wall; and
adhering the façade surface to the backing bracket.

2. The method of claim 1, wherein providing the façade member comprises providing a design member onto the façade member front surface.

3. The method of claim 2, wherein providing the design member onto the façade comprises stamping or roll-forming the design pattern onto the façade member.

4. The method of claim 1, wherein providing the façade member comprises providing a flat metal sheet and roll forming the metal sheet.

5. The method of claim 1, wherein providing the backing bracket comprises:
providing a sheet;
forming the sheet in a tool into a pan shape to form the interior area having a cross section of at least four folded corners; and
forming a top surface, the top surface sized to align and contact a rear surface of the façade member.

6. The method of claim 5, wherein the metal sheet comprises steel.

7. The method of claim 5, wherein forming the metal sheet in a tool further comprises forming a groove and a tongue, wherein the groove is in between a first and a second folded corners and the tongue is in between a third and a fourth folded corners.

8. The method of claim 1, further comprising adhering an overlay surface on top of the façade member.

9. The method of claim 1, wherein adhering an overlay surface on top of the façade member comprises providing an overlay formed of natural wood.

10. A garage door panel assembly, comprising:
a backing bracket having a top wall, a bottom wall and a pair of side walls forming an interior area;
a façade member, the façade member having a front surface and a rear surface, the front surface having a design thereon, the rear surface configured to attach to the top wall of the backing bracket; and
an adhesive, the adhesive securing the façade member to the backing bracket.

11. The panel assembly of claim 10, wherein the adhesive is disposed within the interior area.

12. The panel assembly of claim 10, wherein the adhesive is disposed on the top wall of the backing bracket.

13. The panel assembly of claim 10, further comprising an opening formed in the top of the backing bracket to enable access to the interior area.

14. The panel assembly of claim 10, wherein the façade member further comprises a convex guide extending from the façade member, the convex guide positioned inside a concave receptacle on the backing bracket.

15. The panel assembly of claim 14, wherein the convex guide extends from the edge of the façade member.

16. The panel assembly of claim 1, wherein the concave receptacle is formed on the top wall of the backing bracket.

17. The garage door panel assembly of claim 12, wherein the backing bracket further comprises a concave guide for receiving the convex guide.

18. The garage door panel assembly of claim 11, wherein the top wall of the backing bracket comprises and upturned end for mating with the façade member.

19. The garage door panel assembly of claim 11, wherein the backing bracket further comprises a groove and a tongue disposed on respective sidewalls.

20. The garage door panel assembly of claim 11, wherein the façade member is formed of a piece of metal, a piece of urethane, a piece of composite including fiberglass and resin, or a piece of plastic.

21. The panel assembly of claim 11, wherein the adhesive is expandable foam filled within the interior area.

22. A garage door panel assembly comprising:
a stainless steel backing bracket bent to form at least four bends and having a receiving planar frontal surface between an edge of the stainless steel backing bracket and one of the at least four bends closest to the edge;
a flat plywood layer mated onto the receiving planar frontal surface and aligned with the stainless steel backing bracket;
a filler material filling in between the flat plywood layer and the stainless steel backing bracket for insulation and adhering the flat plywood layer to the stainless steel backing bracket; and
an outer layer adhered onto the flat plywood layer, the outer layer made of real wood and shaped with decorative designs.
